(19) United States
(12) Patent Application Publication
(10) Pub. No.: US 2025/0347632 A1
(43) Pub. Date: Nov. 13, 2025

(54) TERAHERTZ NONDESTRUCTIVE TESTING APPARATUS AND METHOD

(71) Applicant: San Diego State University (SDSU) Foundation, DBA San Diego State University Research Foundation, San Diego, CA (US)

(72) Inventors: George Youssef, San Diego, CA (US); Gregory Sawvelle, San Diego, CA (US); Nha Uyen Huynh, San Diego, CA (US)

(21) Appl. No.: 18/871,777

(22) PCT Filed: Jun. 22, 2023
(86) PCT No.: PCT/US2023/068868

§ 371 Date: Dec. 4, 2024

Related U.S. Application Data
(60) Provisional application No. 63/355,069, filed on Jun. 23, 2022.

(51) Int. Cl. G01N 21/95; B29C 64/386; B33Y 30/00; B33Y 50/00; G01N 21/3563; G01N 21/3581

(52) U.S. Cl. CPC G01N 21/95; B29C 64/386; B33Y 30/00; B33Y 50/00; G01N 21/3563; G01N 21/3581

(57) ABSTRACT

A non-destructive testing apparatus includes a terahertz emitter configured and positioned to be directed at a surface that receives material for additive manufacturing. A terahertz receiver is configured and positioned to receive reflected terahertz radiation from the surface. One or more movement mechanisms are configured to create relative movement between the surface and the terahertz receiver to provide data sufficient for tomographic reconstruction of the material for additive manufacturing. The terahertz nondestructive testing apparatus can be within a 3D printing system, and can conduct testing while 3D printing is being conducted.

### PRIORITY CLAIM AND REFERENCE TO RELATED APPLICATION

The application claims priority under 35 U.S.C. § 119 and all applicable statutes and treaties from prior U.S. provisional application Ser. No. 63/355,069, which was filed Jun. 23, 2022.

### STATEMENT OF GOVERNMENT INTEREST

This invention was made with Government support under Grant Number 1925539 awarded by the National Science Foundation and Grant Number W911NF1810477 awarded by the Department of Defense. The Government has certain rights in this invention.

### FIELD

Fields of the invention include in operando, in situ and ex situ nondestructive testing, additive manufacturing, polymers, polymer matrix composite materials, and 3D printing of such materials irrespective of the form or geometry.

### BACKGROUND

Polymers (plastics in different forms: bulk, foam, fibers, or shaped in any geometry) and composite materials are important classes of materials prevalent in the transportation (e.g., automotive, marine, aerospace, or space) and biomedical (for internal or external prostheses) industries due to their desirable and tunable mechanical properties. These properties include, but not limited to, high strength-to-weight and stiffness-to-weight ratios, i.e., strength and stiffness at low weight. In transportation applications, these properties have an advantageous power-to-weight ratio and can increase fuel efficiency.

Polymers and composites can be formed into simple and complex parts and devices via advanced additive manufacturing, e.g., 3D printing. An example 3D printing technique uses a material extrusion process. A plastic filament is heated while passing through a nozzle, then laid on a print plate (heated or otherwise). The location at which the filaments are laid is based on the part's geometry. In the case of composite materials, the filament can be reinforced with continuous or chopped (discontinuous) fibers (e.g., glass, carbon, etc.). Alternatively, a tape consisting of many fibers pre-impregnated with a polymer resin that is cured thermally or using ultraviolet radiation can be used in the 3D printing of composite parts.

3D printing has been popular in the prototyping space. There is great interest in expanding the use of 3D printing in the production of deployable and functional parts. 3D printing remains less popular in the manufacturing setting than conventional subtractive manufacturing (e.g., milling, turning, drilling, etc.).

A reason that 3D printing has not supplanted conventional subtractive manufacturing is that 3D printing can introduce manufacturing defects randomly. Such defects affect the mechanical performance of parts. Extensive post-fabrication testing and evaluation is needed when there is a risk of manufacturing defects.

Post-fabrication testing can be conducted destructively (i.e., beating and breaking the part) or non-destructively by leveraging different parts of the electromagnetic spectrum (such as X-ray or infrared) or even acoustic waves. Nondestructive evaluation techniques can shorten the inspection and testing times before deployment. However, typical existing nondestructive testing methods are not suitable for concurrent inspection during 3D printing. For example, ultrasound inspection requires physical contact with the part using viscous coupling media. This would interfere with the 3D printing operation and could alter or deform the part being additively formed. X-ray computed tomography requires a safety enclosure due to the ionizing properties of X-ray, to avoid harming people and parts. Such an enclosure is impractical to use with a 3D printing device.

Infrared has been used for inspection of parts. See, e.g., Z.-j. Wang, Z.-q. Li, and Q. Liu, “Infrared thermography non-destructive evaluation of lithium-ion battery,” in International Symposium on Photoelectronic Detection and Imaging 2011: Advances in Infrared Imaging and Applications, 2011, vol. 8193: SPIE, pp. 1237-1244. However, infrared thermography is not practical for inspection of 3D printable polymer composites because typical resins are ultraviolet curable. Post-printing (post-cure) heating can also negatively affect the geometrical stability of the finished part.

Conventional testing techniques obtain information about mechanical and structural integrity after failure of a part is induced. Typically, fracture surfaces are mapped using microscopy and spectroscopy methodologies to uncover process-property interrelationships. G. D. Goh, Y. L. Yap, H. Tan, S. L. Sing, G. L. Goh, and W. Y. Yeong, “Process-structure-properties in polymer additive manufacturing via material extrusion: A review,” Critical Reviews in Solid State and Materials Sciences, vol. 45, no. 2, pp. 113-133, 2020. N. U. Huynh, J. Smilo, A. Blourchian, A. V. Karapetian, and G. Youssef, “Property-map of epoxy-treated and as-printed polymeric additively manufactured materials,” International Journal of Mechanical Sciences, vol. 181, p. 105767, 2020. Such postmortem examinations cannot be conducted in situ and cannot elucidate the fundamental mechanisms leading to plastic deformation and ultimate failure.

Recently larger parts have been made via Big Area Additive Manufacturing (BAAM). C. E. Duty et al., “Structure and mechanical behavior of Big Area Additive Manufacturing (BAAM) materials,” Rapid Prototyping Journal, 2017; C. E. Duty, T. Drye, and A. Franc, “Material development for tooling applications using big area additive manufacturing (BAAM),” Oak Ridge National Lab. (ORNL), Oak Ridge, TN (United States). Manufacturing, 2015. BAAM uses chopped fiber polymer matrix composites. BAAM's print performance also remains a severe challenge that prevents its full adoption for largescale productions (i.e., scaling up). A lack of ability to conduct inspection and evaluation of fiber polymer matrix composites during additive manufacturing is one hurdle to wider use and adoption of BAAM.

Terahertz waves have recently been used for imaging, including medical imaging, and characterizing material systems including polymers and composites. K.-E. Peiponen, A. Zeitler, and M. Kuwata-Gonokami, Terahertz spectroscopy and imaging. Springer, 2012; N. Oda, A. W. Lec, T. Ishi, I. Hosako, and Q. Hu, “Proposal for real-time terahertz imaging system with palm-size terahertz camera and compact quantum cascade laser,” in Terahertz Physics, Devices, and Systems VI: Advanced Applications in Industry and Defense, 2012, vol. 8363: International Society for Optics and Photonics, p. 83630A; M.-A. Brun, F. Formanek, A. Yasuda, M. Sekine, N. Ando, and Y. Eishii, “Terahertz imaging applied to cancer diagnosis,” Physics in Medicine & Biology, vol. 55, no. 16, p. 4615, 2010; N. U. Huynh and G. Youssef, “Ex situ Spectroscopic Characterization of Residual Effects of Thermomechanical Loading on Polyurea,” Journal of Engineering Materials and Technology, vol. 144, no. 3, 2022; N. Huynh and G. Youssef, “Physical Evidence of Stress-Induced Conformational Changes in Polymers,” Experimental Mechanics, vol. 61, no. 3, pp. 469-481, 2021; N. U. Huynh, C. Gamez, and G. Youssef, “Spectro-Microscopic Characterization of Elastomers Subjected to Laser-Induced Shock Waves,” Macromolecular Materials and Engineering, vol. 307, no. 2, p. 2100506, 2022; C.-H. Ryu, S.-H. Park, D.-H. Kim, K.-Y. Jhang, and H.-S. Kim, “Nondestructive evaluation of hidden multi-delamination in a glass-fiber-reinforced plastic composite using terahertz spectroscopy,” Composite Structures, vol. 156, pp. 338-347, 2016; B. Recur et al., “Investigation on reconstruction methods applied to 3D terahertz computed tomography,” Optics express, vol. 19, no. 6, pp. 5105-5117, 2011; J. P. Guillet et al., “Review of terahertz tomography techniques,” Journal of Infrared, Millimeter, and Terahertz Waves, vol. 35, no. 4, pp. 382-411, 2014.

Terahertz-based scanning has been used to detect concealed flaws and voids in post-production quality assurance steps of laminated glass panels. H. Ryu, S.-H. Park, D.-H. Kim, K.-Y. Jhang, and H.-S. Kim, “Nondestructive evaluation of hidden multi-delamination in a glass-fiber-reinforced plastic composite using terahertz spectroscopy,” Composite Structures, vol. 156, pp. 338-347, 2016. This technique was limited to 1) 2D capability and (2) post-manufacturing detection. The 2D scanning is very laborious (even if automated) and requires a priori knowledge of the crack location, i.e., preliminary reconnaissance. The technique also only leveraged a subset of the interactions of terahertz waves with materials in the frequency domain. A similar technique was used by Yahng et. Al. Yahng, Ji Sang, and Dae Su Yee. “High-Speed Time-and Frequency-Domain Terahertz Tomography of Glass-Fiber-Reinforced Polymer Laminates with Internal Defects.” Applied Sciences (Switzerland) 11, no. 11 (June 2021): 4933. Yanhg et. al. using a frequency domain analysis were able to generate and stitch 2D images into 3D topographies. However, this method also only used a subset of the interactions in the frequency domain. The additional subsets allow capture molecular mechanisms which are an underlying contributor to the material properties. This is demonstrated in Huynh, N., and G. Youssef. “Physical Evidence of Stress-Induced Conformational Changes in Polymers.” Experimental Mechanics 61, no. 3 (March 2021): 469-81. https://doi.org/10.1007/s11340-020-00673-7/Published.

Lastly, efforts to evaluate 3D prints with THz have been described by Naftaly, Mira, Gian Savvides, Fawwaz Alshareef, Patrick Flanigan, Gianluc Lui, Marian Florescu, and Ruth Ann Mullen. “Non-Destructive Porosity Measurements of 3D Printed Polymer by Terahertz Time-Domain Spectroscopy.” Applied Sciences (Switzerland) 12, no. 2 (January 2022): 927. This study was limited to identification and quantification of various internal geometric factors such as porosity. There currently is not a unified effort to use THz combining 3D tomography and molecular mechanisms analysis using the frequency domain in-situ to determine a 3D printed parts geometry and strength, which is the aim of this system.

THz-based techniques have been previously integrated on robotic arms for the measurements of paint and coating thicknesses in the automotive industry. Sec, P. F. Taday, M. Pepper, and D. D. Arnone, “Selected Applications of Terahertz Pulses in Medicine and Industry,” Applied Sciences, vol. 12, no. 12, p. 6169, 2022. The analysis was able to detect different layers of paint, and to detect if any layer indicated delamination.

### SUMMARY OF THE INVENTION

A preferred embodiment provides a non-destructive testing apparatus that includes a terahertz emitter configured and positioned to be directed at a surface that receives material for additive manufacturing. A terahertz receiver is configured and positioned to receive reflected terahertz radiation from the surface. One or more movement mechanisms are configured to create relative movement between the surface and the terahertz receiver to provide data sufficient for tomographic reconstruction of the material for additive manufacturing. The terahertz nondestructive testing apparatus can be within a 3D printing system and can conduct testing while 3D printing is being conducted.

### BRIEF DESCRIPTION OF THE DRAWINGS

FIG. 1A is a perspective diagram of a preferred embodiment non-destructive testing apparatus of the invention integrated with a 3D printing systems;

FIG. 1B illustrates optical components of the preferred non-destructive testing apparatus of FIG. 1A;

FIG. 2 illustrates an integration of in situ terahertz imaging and inspection of the invention in a 3D robotic printing apparatus during printing;

FIG. 3 is a schematic representation of image segmentation, registration, and image stitching used to process acquired images.

### DETAILED DESCRIPTION OF THE PREFERRED EMBODIMENTS

The present inventors have determined that terahertz imaging is well-suited to in situ and ex situ examination of additive manufactured parts. The signal-to-noise ratio for frequencies below 3 THz is higher than with most conventional techniques. The detectors operate at room temperature. Terahertz imaging allows for the simultaneous measurements of the complex refractive index (n̅=n+ik, where n is the phase velocity and k is the extinction coefficient), and the thickness of the sample. The sample thickness for the THz-TDS temperature scans is sufficient to characterize a bulk material; hence, surface phenomena like the depression of the glass transition temperature (T_{g}) for thin polymer layers can be neglected. Additionally, many polymers are transparent to the THz wave facilitating in-situ interrogation. Contact-free measurement enables quantifying the material parameters directly, even at cryogenic temperatures, which is important herein as some polymers. No correction or extrapolation of the thermal expansion of the material is required. THz radiation has much lower photonic energies (4 meV for 1 THz) and is nonionizing with no adverse effect on tissues and biomolecules, making it safe for the operator and the samples alike.

Prior publications have failed to provide imaging and analysis that use THz in a manner suitable for 3D printing analysis while combining 3D tomography and molecular mechanisms analysis using the frequency domain in-situ to determine a 3D printed parts geometry and strength. Preferred embodiments provide these capabilities.

Terahertz wavelength is bounded between microwaves and infrared. Terahertz waves are nonionizing, noninvasive, and nondestructive, making them safe for the operator and parts. Terahertz waves have low energy and large penetration depth, i.e., ideal for the investigation of polymers and composites.

Preferred embodiments provide in situ and/or ex situ nondestructive evaluation technique and apparatus suitable for integration within a 3D printer enclosure (heated or otherwise). A preferred embodiment is a stand-alone terahertz-based nondestructive inspection and imaging device that is integrated within the enclosure of a 3D printing apparatus.

Preferred devices generate terahertz waves, and can include nonlinear optics or conductive antennas or arrayed Schottky diodes, and direct the waves toward 3D printing surface, such as a plate or printer bed. The waves pass through layers already printed onto the 3D printing surface. Optical equipment is controlled to adjust an angle, focus and field of illumination to obtain inspection at different depths and locations. The adjustable focal distance can also accommodate an increase in height, width, and length of material as the 3D printing process continues.

A preferred testing device is integrated with a robotic 3D printing device, with the wave generator mounted on the same gantry system as the material deposit nozzle, i.e., the transmitter moves at the same focal point throughout the printing process. A preferred 3D printing device includes a printing surface that is made of metal covered with glass, such that propagating terahertz waves reflect off the plate and are collected by a terahertz receiver positioned to receive reflected waves. The receiver collects the reflected signal and converts it into a detectable and measurable electric signal that is proportional to the number of layers and manufacturing defects if present. The receiver can be a terahertz camera (microbolometer), configured and arranged to collect a digital image of the inspected plane.

A preferred embodiment provides a standalone terahertz-based nondestructive inspection and imaging method and apparatus capable of terahertz-based nondestructive evaluation of 3D printed parts and composites, seamless integration of the system with any 3D printer since the terahertz-based nondestructive evaluation subsystem is independent of the printer design, and real-time reconstruction of the collected terahertz images to create tomograms for inspection and evaluation.

The present stand-alone terahertz-based nondestructive inspection and imaging apparatus can be integrated within the enclosure of any 3D printing apparatus and used to realize polymers and composites parts and structure. Generated terahertz waves are directed towards the 3D printing surface passing through the layers already printed. The angle and field of illumination are adjusted through several optical components attached to the transmitter with adjustable focal distance to accommodate the increase in height, width, and length as the 3D printing process continues. It should be noted that adjustable optics are optional since the transmitter is mounted on the same gantry or motion system as the nozzle or the deposition apparatus, i.e., the transmitter moves at the same focal point throughout the printing process. The user (or intelligent controller) can then continue or abort the print based on the real-time constructed tomograms, increasing manufacturing yield, reducing waste, and helping to proliferate 3D printing in other industrial domains.

The transparency of materials to terahertz waves makes them penetrative through relatively large polymer and composite parts, making it possible to detect manufacturing flaws and defects deep into the part. Compared to ultrasound inspection, this provides a great advantage. Ultrasound is generally sufficient only for detecting superficial cracks and defects. Terahertz waves are also nonionizing, protecting the inspected parts from harmful doses of radiation, such as the case in X-ray-based methods. This nonionizing feature marks terahertz waves as safe for operators as well.

Present terahertz-based imaging systems and methods can be integrated into the XYZ gantry motion system or a robotic arm on an advanced robotic 3D printing system as part of the end effector attachments. In alternative embodiments, the terahertz-based imaging systems and methods as provided herein can be integrated within post-printing inspection and evaluation protocols by placing the terahertz inspection system on an optical bench or any flat surface. In alternative embodiments, the terahertz-based imaging systems and methods as provided herein can also be miniaturized into a handheld or mobile inspection system of large 3D printed parts and structures.

In alternative embodiments, the terahertz-based imaging systems and methods as provided herein comprises a post-acquisition subsystem, which comprise, or consists of, a new reconstruction software, initially built into a commercially available engineering programming software, e.g., MATLAB, or automation software, e.g., LABVIEW. The reconstruction algorithm is independent of the programming language. The algorithm can be deployed as standalone, deployable, executable software that can build terahertz tomograms based on the printer's motion, i.e., correlating the printing location with the collected terahertz images.

Preferred methods of imaging used in embodiments include transmission terahertz imaging (preferably used in ex situ imaging, i.e., after printing) and reflective terahertz imaging (preferably used in situ image, i.e., during printing).

A preferred embodiment provides a terahertz-based nondestructive inspection and imaging apparatus. Generated terahertz waves are provided by a generator that can include nonlinear optics, conductive antennas, or Schottky diodes, for example. The terahertz waves are directed towards a 3D printing location, such as a plate, or a printer bed. The path can be direct or via an indirect optical path, such as via a terahertz reflective surface (metallically or otherwise coated plane). The terahertz waves pass through layers already printed; and the angle and field of illumination are adjusted through several optical, locomotion, and electronic components attached to the transmitter with adjustable focal distance to accommodate the increase in height, width, and length as the 3D printing process continues. Returning terahertz radiation is detected and digitized. Optics for the return radiation can include nonlinear optics, conductive antennas, or microbolometers (cooled or otherwise). Additional optical or electronic filters are preferably arranged to filter thermal effects associated with 3D additive manufacturing. Collected terahertz signals or digitized plane arrays can be constructed into terahertz tomograms using conventional tomographic reconstruction algorithms. The constructed tomograms can be compared to the printed part original design to report defects or flaws. The nondestructive terahertz process can be also applied ex-situ with the same arrangement after the printed part has been completed.

A preferred embodiment provides a non-destructive testing apparatus that includes a terahertz emitter configured and positioned to be directed at a surface that receives material for additive manufacturing. A terahertz receiver is configured and positioned to receive reflected terahertz radiation from the surface. One or more movement mechanisms are configured to create relative movement between the surface and the terahertz receiver to provide data sufficient for tomographic reconstruction of the material for additive manufacturing. The terahertz nondestructive testing apparatus can be within a 3D printing system and can conduct testing while 3D printing is being conducted.

A preferred method for terahertz nondestructive testing apparatus is conducted within a 3D printing system. The method includes positioning a terahertz emitter to be directed at a surface that receives material for additive manufacturing while a printing head of the 3D printing system is printing material on the surface. A terahertz receiver is positioned to receive reflected terahertz radiation from the surface. Relative movement is created between the surface and the terahertz receiver to obtain data sufficient for tomographic reconstruction of the material for additive manufacturing. The steps are preferably conducted periodically while the printing head of the 3D printing system is printing material.

Preferred embodiments of the invention will now be discussed with respect to experiments and drawings. Broader aspects of the invention will be understood by artisans in view of the general knowledge in the art and the description of the experiments that follows.

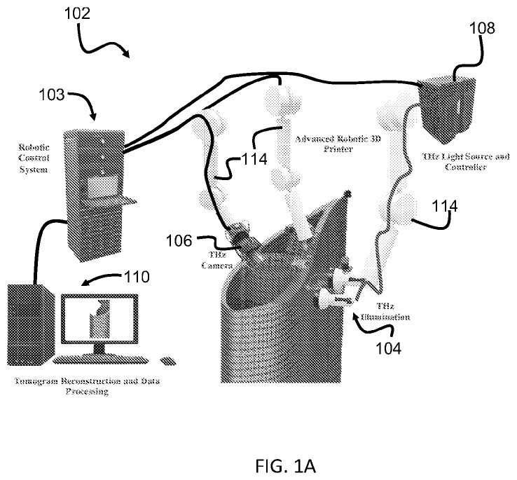

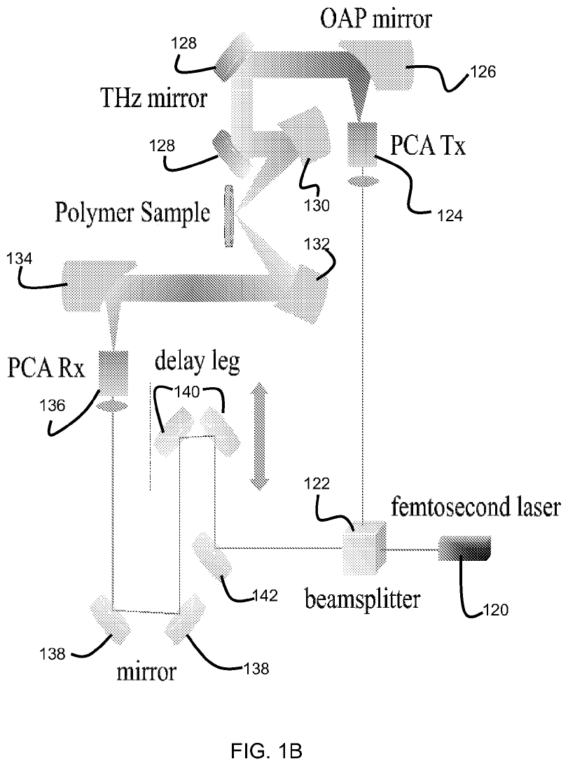

FIG. 1A shows a preferred embodiment robotic 3D printing system 102 that includes a terahertz imaging apparatus of the invention. The printing system 102 can be a commercial robotic 3D printer 103 capable of depositing complex geometry and largescale parts with different polymers, polymers with reinforcing fibers, matrix materials, etc. The terahertz imaging apparatus includes THz wave generators 104, a THz sensor 106, a THz controller 108 and tomogram reconstruction computer/software 110. The THz wave generators 104, THz sensor 106 and a 3D printing head 112 are mounted on robotic arms 114 that are capable of precision positioning with freedom of movement in X, Y, and Z directions as well as rotation of the heads/ends of the arms.

The THz wave generators 104, THz sensor 106, THz controller 108 and tomogram reconstruction computer/software 110 provide terahertz tomography nondestructive and penetrative imaging, which can be conducted in situ (while a part is being deposited by the 3D printer 103). The Terahertz tomography enables complete subsurface imaging of concealed cracks, voids, and manufacturing defects and imperfections while simultaneously extracting spectroscopic data about the printed materials. Terahertz mapping and imaging can be conducted from the sensed data.

The 3D printer 103 is preferably configured to deposit wide variety of fibers and matrix material, and is preferably capable of meter-scale polymer composite parts. The preferred 3D printer robot 103 can print very tall, long, and wide parts. The THz imaging provided in the system 102 can be used, for example, to provide a scientific understanding of (1) mechanics of largescale 3D printed structures, departing from testing lab-scale replicas, coupon testing, and prototyping, and (2) identify challenges of scaling-up the print size to mitigate these challenges. The 3D printer can manufacture parts using various materials, e.g., thermoplastic, thermoset, and coaxial continuous fiber, using any standard or other end-effectors technology.

FIG. 1B illustrates optical and optomechanical components of a preferred system consistent with the system 102 of FIG. 1A. A pulsed femtosecond laser 120 is used to excite THz waves that are transmitted from the transmitting photo conductive antenna (PCA) 124. A beam splitter 122 splits the laser beam into two paths, a reference optical path and the THz generating path. The PCA transmitter 124 generates the THz waves. An off axis parabolic (OAP) mirror 126 is used to collimate the THz waves emitted by the PCA 124. THz mirrors 128 direct the collimated waves to a second OAP 130 that focuses the THz radiation at a sample. A reflected THz signal is received by a third OAP 132, collimated and directed to a final OAP 134 and then to a PCA receiver 136. The receiving PCA simultaneously receives the reference optical beam and THz beams, then converts the THz waves into measurable electrical signals. Optical mirrors 138 and 142 direct the laser beam to the detecting PCA 132. Mirrors 140 form a delay leg that adjusts the optical path to allow observation of the THz pulse without the need for high-speed electronics.

A prototype terahertz imaging system consistent with FIG. 1A consisted of an INO terahertz camera (broadband 0.1-4.25 THz) fitted with F/0.6 lens (ultrafast refractive optics with 44 mm focal length) with a projected field of view of ˜75×100 mm and Schottky diode terahertz light source with a central frequency of ˜0.5 THz and power of ˜1.25 mW. The illumination source matches the aspect ratio of the focal plane arrays (FPA) and is compatible with reflection and transmission capture modes. The terahertz light source illuminates>75×100 mm of nearly flat top illumination, avoiding edge effects to vividly capture true, undistorted images with minimal artifacts. FPA-based imaging is preferred to raster scanning using single pixel sensors as the FPA-based imaging is superior for full reconstruction and small feature detection.

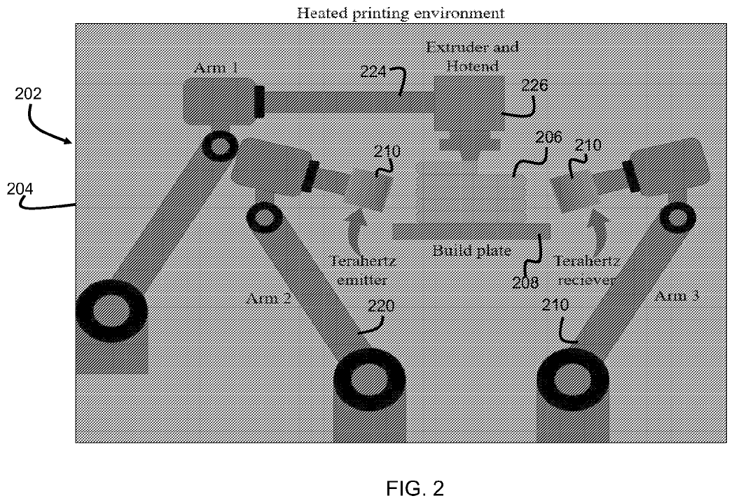

FIG. 2 shows another preferred printing system 202, that is generally consistent with the system 102 of FIG. 1A. The system 202 provides a heated environment 204, which can also be an enclosure with a heat source. A sample 206 is formed on a surface 208, which can be a build plate mounted on an XYZ motion system, i.e., a gantry, where the XY motion stage, in the plane parallel to an illumination source-THz emitter 210 and a focusing lens of a THz receiver 212, allows strategic partitioning of the largescale sample while keeping tracking of the corresponding locations. Z-axis motion can move the sample 206 closer or away from the THz receiver 212 to capture a new section at the focal point of its lens while keeping track of the depth location. Robotic arms 220 and 222 carry and position the THz emitter 210 and the THz receiver 212. Robotic arm 224 carries a printing head formed of a hot-end extruder/nozzle 226.

The terahertz imaging setup in the system of 202 emulates optical microscopy of transparent samples, where focusing can be achieved by bringing the lens closer or away from the plane of interest. The XY stage of the surface 208 can be calibrated using a terahertz opaque surface except for a few landmarks (holes) located at specific distances from one another, e.g., a pre-fabricated plate with holes at a prescribed pattern. The calibration object can have a homing location to ensure the precise positioning of the sample at the onset of each scan.

Images obtained are processed to avoid losing any major details and provide stitching, preferable via image overlapping. In the overlapping, a specific portion of the previous image is recaptured during a following imaging step. In addition to facilitating stitching, the overlap can be used to enhance the resolution, identify, and eliminate imaging artifacts, and improve contrast. Overlapping percentages can range from 30-70%. At the higher range of the overlap, the imaging time and post-processing are increased extensively, while the image quality will suffer at the other end of the range. A balance can be achieved between the image quality and inspection (imaging) time. The imaging time can be set according to deposit speed of the item being fabricated.

Overshadowing of smaller features at the focal plane by larger features ahead of the focal plane (i.e., closer to the camera) can be managed using an additional rotation degree of freedom to tilt the surface 208 away from the focusing plane. The location-annotated images can then be stacked and stitched. Providing rotation of the surface 208 is helpful for tomography.

For evaluation of largescale 3D printed PMCs parts with accuracy to detect manufacturing defects and flaws, usually sub-millimeter size, the planar surface of the inspected part can be divided into smaller areas (images) based on the field of view of the previously configured camera and illumination system. Image registration can be used to identify and match features in the image set acquired in a previous imaging stage to align the sequence and stitch a panoramic image of the inspected part. In the feature matching step, only adjacent images are searched for similar features, which is facilitated since the images are annotated and collated based on the location dictated to the XYZ motion stage during imaging scans.

To accelerate the feature search and matching, a 3D solid model used in printing the part or a rough optical image can also be provided into the stitching algorithm. Once the common features between two subsequent images are identified, overlapping can be performed by minimizing the sum of the absolute difference between the corresponding pixels. The minimization can be achieved through incremental pixel-level translations and rotations of the overlapping pixels in the identified features. The minimization approach is preferred over other techniques, such as matching of the centroid of the features.

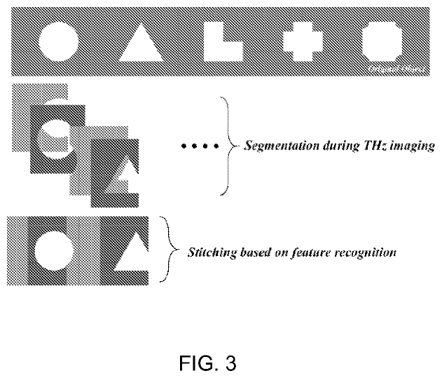

Corrections can be applied to adjust contrast and brightness based on set of calibrated images from the previous stage and the color histograms of the two subsequent images. A schematic representation of the image segmentation, registration, and image stitching is shown in FIG. 3. A preferred tomography process is described next.

Tomography is the reconstruction of the object volume from a set of projections from the exterior of the object while either the object or the imaging beam rotates. Tomography is ubiquitous in many scanning methods, including X-ray CT, single photon emission CT, transmission electron microscopy, and electro-magnetic radiation in the continuous or pulsed THz CT. Tomography reconstruction from projections has been done through several techniques such as the Radon transform (the most common approach). In the present system 202, the sample 206 can be moved axially or laterally to collect THz transmission images. The sample 206 can then be rotated in the field of view of the terahertz camera 210 to collect transverse projections. Then, the reconstruction process of THz tomograms as described in J. P. Guillet et al., “Review of terahertz tomography techniques,” Journal of Infrared, Millimeter, and Terahertz Waves, vol. 35, no. 4, pp. 382-411, 2014 can be used. The Radon transform, R_{θ}(ρ), maps a 2D function, ƒ(x, y), into a 1D projection along θ angle and a module (ρ).

$${R}_{θ} ( ρ ) = \int {\int }_{- ∞}^{∞} f ( x , y ) δ ( ρ - x cos θ - y sin θ ) dxdy \qquad ( 1 )$$

where, θ and ρ are the angular and radial coordinates of the projection line, δ is the impulse function, and x and y are the Cartesian coordinates of the transverse slice. For one horizontal cross-section, the acquisition along several angles gives a sinogram composed with N_{θ} lines projections and N_{ρ} pixels in the horizontal direction. Any open-source or proprietary programming language can be used to accomplish the reconstruction process, e.g., MATLAB® and Python° or open-source tomography software (e.g., tomviz).

A preferred imaging procedure first records 2D THz transmission images of the sample by translating the part using the XY stage with small step size. The scan speed and the XY translational step size define the scan time. The part can then be rotated by dθ rotation step to visualize the part from different perspectives, which is repeated N_{θ}, where θϵ[0,180], to enhance the visualization abilities in the reconstruction algorithm. From the projection data, sinograms of the part are constructed based on the evolution of the transmitted THz amplitude as a function of the rotation angle. This procedure can be repeated for 3D printed polymeric and PMCs parts

The terahertz detectors or imager are mounted on a cradle that is attached to the same robotic arm as the printing end effector or standalone robotic arm, ensuring the detectors or imager is always facing the illuminated area by the terahertz light source. The terahertz light will illuminate a region of interest using a THz light transportation system (microscope gooseneck-like, e.g., flexible waveguide used in microwave antennas) to ensure that the THz light source is anchored at the base of the printing system outside the printing enclosure. At each joint along the robotic arm, swivel light joints are properly secured, consisting of two THz prisms that transfer the THz light from one waveguide to the next. The camera will be rotating around the part, using the available degrees of freedom of the robotic arm, to collect the required line projections for the reconstruction step.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 75%, 80%, 85%, 90%, 91%, 92%, 93%, 94%, 95%, 96%, 97%, 98%, 99% or 99.5%, or more of a referenced amount of a composition.

The entirety of each patent, patent application, publication and document referenced herein hereby is incorporated by reference. Citations of the above patents, patent applications, publications and documents are not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A terahertz nondestructive testing apparatus, comprising:
a terahertz emitter configured and positioned to be directed at a surface that receives material for additive manufacturing;
a terahertz receiver configured and positioned to receive reflected terahertz radiation from the surface; and
one or more movement mechanisms configured to create relative movement between the surface and the terahertz receiver to provide data sufficient for tomographic reconstruction of the material for additive manufacturing.

2. The terahertz nondestructive testing apparatus of claim 1, wherein the terahertz emitter and the terahertz receiver are mounted on robotic arms.

3. The terahertz nondestructive testing apparatus of claim 2, wherein the surface comprises a build plate mounted on an XYZ motion system.

4. The terahertz nondestructive testing apparatus of claim 1, within a 3D printing system.

5. The terahertz nondestructive testing apparatus within a 3D printing system of claim 4, wherein the 3D printing system comprises a robot arm and a printing head that is movable with respect to the surface to conduct 3D printing of material on the surface.

6. The terahertz nondestructive testing apparatus within a 3D printing system of claim 5, wherein the terahertz emitter is mounted on a second robot arm, and the terahertz receiver is mounted on a third robot arm.

7. The terahertz nondestructive testing apparatus within a 3D printing system of claim 6, wherein second and third robot arms are configured to be arranged such that terahertz radiation is reflected from the surface to the terahertz receiver.

8. The terahertz nondestructive testing apparatus within a 3D printing system of claim 4, wherein the 3D printing system comprises an enclosure and the terahertz emitter, receiver, the surface and the printing head are mounted within the enclosure.

9. The terahertz nondestructive testing apparatus within a 3D printing system of claim 8, wherein the enclosure comprises a heated enclosure.

10. The terahertz nondestructive testing apparatus within a 3D printing system of claim 4, wherein one or more of the surface, terahertz emitter, and terahertz receiver are configured to be moved axially or laterally.

11. The terahertz nondestructive testing apparatus within a 3D printing system of claim 4, wherein the surface is configured to be rotated to collect transverse projections.

12. The terahertz nondestructive testing apparatus of claim 1, comprising a tomographic reconstruction computer that receives the data and performs reconstruction via a Radon transform.

13. A method for terahertz nondestructive testing apparatus within a 3D printing system, the method comprising:
positioning a terahertz emitter to be directed at a surface that receives material for additive manufacturing while a printing head of the 3D printing system is printing material on the surface;
positioning a terahertz receiver to receive reflected terahertz radiation from the surface; and
creating relative movement between the surface and the terahertz receiver to obtain data sufficient for tomographic reconstruction of the material for additive manufacturing.

14. The method of claim 13, conducted periodically while the printing head of the 3D printing system is printing material.
